(19) United States
(12) Patent Application Publication
(10) Pub. No.: US 2007/0091780 A1
(43) Pub. Date: Apr. 26, 2007

(54) MULTI-LAYER OPTICAL RECORDING MEDIUM

(75) Inventor: YASUSHI HOZUMI, Ageo-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, TOKYO (JP)

(21) Appl. No.: 11/539,243

(22) Filed: Oct. 6, 2006

(30) Foreign Application Priority Data
Oct. 26, 2005 (JP) 2005-311377

(51) Int. Cl. G11B 7/24

(52) U.S. Cl. 369/275.4

(57) ABSTRACT

In a multi-layer optical recording medium having an extremely thin recording layer for further multilayering, good recording/reproducing characteristics are realized. Specifically, a multi-layer optical recording medium includes a first recording layer L1 having a groove and a second recording layer Li having a groove deeper than that of the first recording layer L1, provided closer to a light incident surface than the first recording layer L1.

### BACKGROUND OF THE INVENTION

1. Field of the Invention

The present invention relates to an optical recording medium for reproducing or recording information with a laser beam, and more specifically, to a multi-layer optical recording medium.

2. Description of the Related Art

As a large-capacity memory capable of rewriting information, an optical recording medium from/to which information is reproduced/recorded with a laser beam is receiving attention. As the optical recording medium, there have been proposed a read-only optical recording medium in which information is recorded by the arrangement of pits and only the reproduction of information can be performed, a phase-change type optical recording medium and a magneto-optical recording medium in which information can be recorded only once or a plurality of times, and the like.

In such an optical recording medium, a beam waist diameter 2Wo is determined by a laser wavelength λ of a reproducing optical system and a numerical aperture NA of an objective lens (specifically, 2Wo=K·λ/NA). Therefore, in the optical recording medium, as a spatial frequency, up to about 2 NA/λ can be detected during reproduction of a signal. However, the demand for a larger capacity of the optical recording medium is increasing. In order to satisfy the demand, a multi-layer optical recording medium that achieves the increase in capacity by providing a plurality of recording layers is being developed.

For example, in J. Appl. Phys., 69, 2849, 1991 by N. Yamada et al. and Technical Digest of ISOM/ODS 2002 ThC., 1, 404, 2002 by N. Yamada et al., the following developments are reported. In a digital versatile disc (DVD) with a disk diameter of 12 cm, which is one of the phase-change type optical recording media, a reproducing optical system with a laser wavelength λ of 650 nm and a NA of 0.60 is used, and the storage capacity thereof is 4.7 GB in a case of the single layer type. When the DVD is made two-layered, the storage capacity increases to 8.5 GB. Furthermore, in recent years, there has been developed an optical recording medium with a disk diameter of 12 cm using a reproducing optical system with a further reduced spot diameter such as, for example, a laser wavelength λ of 405 nm and a NA of 0.85). The storage capacity of the optical recording medium is 25 GB in a case of the single-layer type. However, when the optical recording medium is made two-layered, the storage capacity can be increased to 50 GB. Thus, when a plurality of recording layers are provided in one recording medium, the storage capacity increases by the number of recording layers. Therefore, the multilayering technique is one of effective means for increasing the capacity of an optical recording medium.

In such a multi-layer optical recording medium, recording layers other than a recording layer (hereinafter, sometimes referred to as “deepest recording layer”) which is most distant from a light incident surface need to be so configured as to have a light transmitting property in a laser wavelength of a recording/reproducing optical system, and allow light to reach the deepest recording layer. The purpose for this is to perform recording/reproduction with respect to the deepest recording layer satisfactorily, and a transmittance necessary for transmission up to the deepest recording layer is said to be at least 50%.

In order to ensure the transmittance to the deepest recording layer, light absorbing material layers of the recording layers other than the deepest recording layer is formed as thinly as possible. For example, in a two-layered optical recording medium using a reproducing optical system with a laser wavelength λ of 405 nm and a NA of 0.85, the film thickness of a recording layer closer to a light incident surface is 6 nm in a phase change layer ((Ge,Sn)SbTe), and is 10 nm in an Ag alloy reflective layer. The film thickness of the deepest recording layer is 10 nm in a phase change layer (GeSbTe) and is 80 nm in an Ag alloy reflective layer. Therefore, the film thickness of the recording layer closer to the light incident surface is very thin. Then, in a multi-layer optical recording medium of three, four, or more layers which realizes a further increase in capacity, the phase change layers of recording layers other than a deepest recording layer need to be as thin as about 3 nm. By reducing the film thickness to such an extent, the intensity attenuation of a recording laser beam on the deepest recording surface can be reduced to about 50%. Thus, the film thicknesses of at least recording layers other than a deepest recording layer need to be made small along with the increase in number of recording layers.

However, in the case where the film thickness of a recording layer (phase change layer) is made small, the smaller the film thickness, the less likely that atoms will move. Therefore, the rate of crystallization for erasing a signal decreases. Specifically, in a GeTe—Sb₂Te₃-based phase change material, when the film thickness is set to be smaller than 8 nm, laser irradiation for a longer period of time is required, which increases the time from the laser irradiation to the completion of crystallization. This means that the reduction in the film thickness to such an extent has an adverse effect in the case where a small recording mark is recorded by laser irradiation for a short period of time, which is a serious problem for high-density recording and a high-speed transfer rate.

In order to solve this problem, a new phase change material is being developed. For example, the above-mentioned (Ge,Sn)SbTe obtained by substituting a part of Ge with Sn in the GeTe—Sb₂Te₃-based material can be used even in a film thickness of 8 nm or less, specifically, about 5 nm. However, even in the (Ge,Sn)SbTe, the tendency that within a film thickness range of 5 nm or less, the crystallization rate decreases as the film thickness is reduced still remains. Therefore, the above-mentioned problem is a serious obstacle for an optical recording medium (for example, a multi-layer optical recording medium of four or more layers) for which a higher transmittance of recording layers is required, particularly, for a rewritable optical recording medium in which information can be rewritten a plurality of times.

### SUMMARY OF THE INVENTION

In view of the above-mentioned problems, an object of the present invention is to realize good recording/reproducing characteristics in a multi-layer optical recording medium having extremely thin recording layers for further multilayering.

Specifically, according to a first aspect of the present invention, there is provided a multi-layer optical recording medium, which comprises a substrate and at least two recording layers each having a groove which are stacked on the substrate, wherein the groove of a recording layer other than a recording layer which is most distant from a light incident surface of the at least two recording layers is deeper than the groove of the recording layer most distant from the light incident surface.

According to a second aspect of the present invention, there is provided a multi-layer optical recording medium, which comprises a substrate and at least two recording layers each having a groove which are stacked on the substrate, wherein a recording layer other than a recording layer which is most distant from a light incident surface of the at least two recording layers is smaller in amplitude of push-pull signal based on a groove than the recording layer most distant from the light incident surface.

Further features of the present invention will become apparent from the following description of exemplary embodiments with reference to the attached drawings.

### BRIEF DESCRIPTION OF THE DRAWINGS

FIG. 1 is a schematic cross-sectional view showing one embodiment of the multi-layer optical recording medium of the present invention.

FIG. 2 is a schematic structural view of a multi-layer optical recording medium according to one example of the present invention.

FIG. 3 is a schematic structural view of a recording/reproducing apparatus for an optical recording medium used in one example of the present invention.

FIG. 4 is a view showing waveforms of a push-pull signal in each information layer of a multi-layer optical recording medium, measured in one example of the present invention.

### DESCRIPTION OF THE EMBODIMENTS

Hereinafter, embodiments of a phase-change type multi-layer optical recording medium according to the present invention will be described with reference to the drawings.

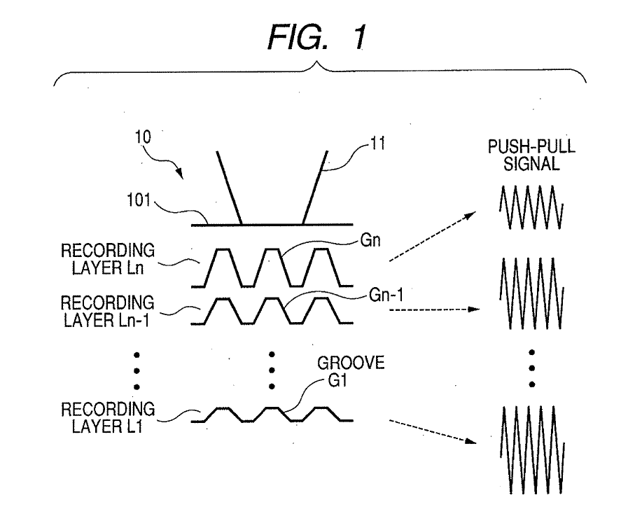

FIG. 1 is a schematic cross-sectional view showing one embodiment of the multi-layer optical recording medium of the present invention. In a multi-layer optical recording medium 10, n recording layers L1 to Ln are stacked, and a light incident surface 101 is irradiated with a laser beam 11. The recording layers have a multi-layered configuration including from a first recording layer L1 (i.e., the deepest recording layer) which is most distant from the light incident surface 101 to an n-th recording layer Ln which is closest to the light incident surface 101. Herein, n is an arbitrary integer of 2 or more.

At least one of from the second recording layer L2 to the n-th recording layer Ln is formed so as to have a heat capacity per bit which is larger than that of the first recording layer L1. The heat capacity per bit of the first recording layer L1 is more preferably set to be smaller than that of any one of the other recording layers L2 to Ln. Such a difference in heat capacity can be achieved by making the shape of the grooves of the first recording layer L1 different from the shapes of the grooves of the other recording layers L2 to Ln. In the present embodiment, although the depth of the grooves of each of the recording layers L2 to Ln is set to be larger than that of the first recording layer L1, the groove width may be varied, or both the groove depth and the groove width may be varied. In the configuration shown in the figure, the depths of grooves G1 to Gn of the respective recording layers are set to sequentially increase from the first recording layer L1 to the n-th recording layer Ln, i.e., to increase in the order from the groove G1 to Gn. In this case, the heat capacity per bit of each recording layer increases sequentially from the first recording layer L1 to the n-th recording layer Ln.

The recording layers L1 to Ln are crystallized in an initialized state. Information is recorded by modulating the irradiating laser beam 11 to a high peak power Phigh (mW) and a low bias power Pb (mW). The temperature is raised to a crystallization temperature or more by the irradiation of the laser beam 11 of the Phigh, followed by rapidly cooling, whereby an amorphous phase is formed to become a recording mark. At a region between the recording marks, the temperature is raised to a crystallization temperature or more by the irradiation with the laser beam 11 of the Pb, followed by slow cooling, whereby a crystal phase is formed. The first recording layer L1 and the other recording layers L2 to Ln that are light transmitting layers are different in groove depth as described above, and the heat capacities per bit of the recording layers L2 to Ln are larger than that of the first recording layer L1 accordingly. Therefore, even in the case where the film thicknesses of the light transmitting recording layers are small, the heat energy can be accumulated in the recording layers due to the heat accumulating effect caused by the physical shape of the grooves, whereby crystallization can be performed satisfactorily even by the irradiation of a laser for a short period of time. To be more specific, the recording sensitivities of the recording layers L2 to Ln are set to be higher, so that recording (or erasing) can be performed even by laser irradiation with a smaller laser power or for a shorter period of time.

In such a multi-layer optical recording medium, as shown also in FIG. 1, the push-pull signal amplitude by the first groove G1 of the first recording layer L1 is set to be larger than that by the i-th groove Gi of at least another recording layer Li. The push-pull signal amplitude by the first groove G1 is more preferably set to be larger than that by the grooves G2 to Gn of any other recording layers L2 to Ln. Furthermore, in the present embodiment, the push-pull signal amplitudes by the grooves G1 to Gn of the respective recording layers L1 to Ln are set to sequentially decrease from the recording layer L1 to the recording layer Ln. In the multi-layer optical recording medium, a recording layer which is more distant from the light incident surface receives a larger influence of aberration, and the influence on a servo and signal characteristics with respect to a tilt becomes larger. To be more specific, in a recording layer which is more distant from the light incident surface, the margin of the servo and signal characteristics with respect to a tilt decreases. By forming a groove so that the push-pull signal amplitude becomes larger as the distance of the recording layer and the light incident surface becomes larger, such an adverse influence is reduced, thereby making it easier to ensure a tilt margin.

### EXAMPLES

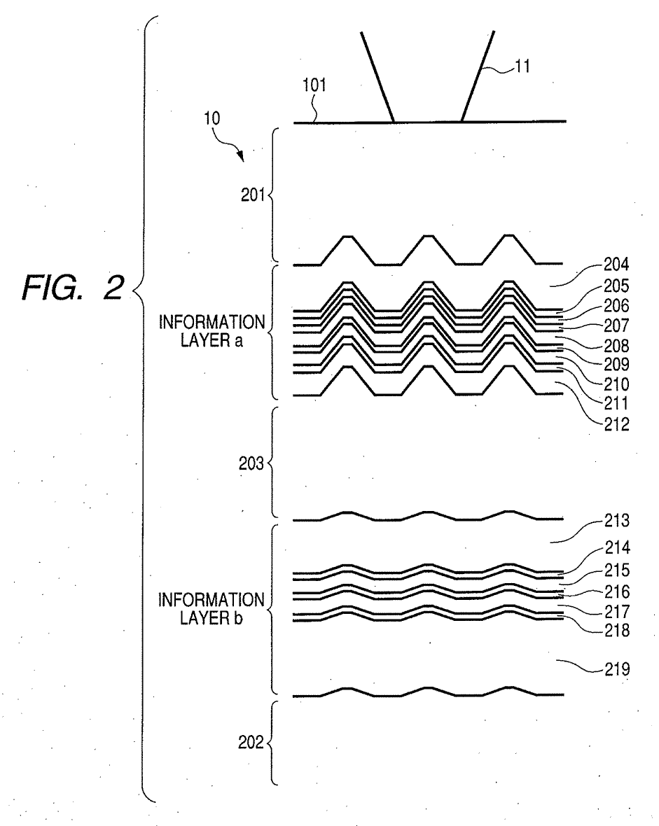

FIG. 2 is a structural view of a multi-layer optical recording medium according to one example of the present invention. Hereinafter, the structure and production method of the present example will be described. The present example has two recording layers, in which a layer including a first recording layer is set to be a first information layer a, and a layer including a second recording layer is set to be a second information layer b.

First, as a substrate 201 of the first information layer a, a polycarbonate (PC) sheet with a thickness of 75 μm was prepared. The substrate 201 was a groove recording substrate having a substrate groove shape with a track pitch of 320 nm, a groove width of 100 nm, and a groove depth of 85 nm. Herein, a groove surface closer to the incident surface 101 of the laser beam 11 is defined as a groove. The groove width is defined in terms of a half value width of the groove depth. In the present example, in order to enhance the sensitivity with respect to a laser beam while ensuring the signal quality, the above-mentioned groove width and groove depth were set. However, the sensitivity with respect to a laser beam can be enhanced by further decreasing the groove width or increasing the groove depth, as long as the signal quality can be ensured. In the present example, although polycarbonate (PC) was used for the substrate 201, polymethylmethacrylate (PMMA), amorphous polyolefin (APO), or the like may be used as a forming material. The so-called 2p substrate using a UV-curable resin may also be used. Furthermore, in the present example, although the groove recording substrate was used, a land recording substrate or land/groove recording substrate can also be used. In the case of land recording, the photosensitivity is enhanced by getting the land width as large as possible to such a degree that a recording power margin can be ensured.

On the substrate 201 of the first information layer a, there were successively formed by sputtering a first dielectric layer 204 (thickness: 45 nm), a first interface layer 205 (thickness: 3 nm), a first recording layer 206 (thickness: 3 nm), a second interface layer 207 (thickness: 3 nm), a second dielectric layer 208 (thickness: 11 nm), a third interface layer 209 (thickness: 3 nm), a first reflective layer 210 (thickness: 10 nm), a fourth interface layer 211 (thickness: 3 nm), and a third dielectric layer 212 (thickness: 23 nm).

Next, as a substrate 202 of the second information layer b, a polycarbonate (PC) sheet with a thickness of 1.1 mm was prepared. The substrate 202 was a groove recording substrate having a substrate groove shape with a track pitch of 320 nm, a groove width of 150 nm, and a groove depth of 34 nm. Herein, a groove surface closer to the incident surface 101 of the laser beam 11 is defined as a groove. In the present example, although polycarbonate (PC) is used for the substrate 202, polymethylmethacrylate (PMMA), amorphous polyolefin (APO), or the like may be used as a forming material. The so-called 2p substrate using a UV-curable resin may also be used. Furthermore, in the present example, although the groove recording substrate was used, a land recording substrate or land/groove recording substrate can also be used.

On the substrate 202 of the second information layer b, there were formed sequentially by sputtering a second reflective layer 219 (thickness: 80 nm), a seventh interface layer 218 (thickness: 3 nm), a fifth dielectric layer 217 (thickness: 11 nm), a sixth interface layer 216 (thickness: 3 nm), a second recording layer 215 (thickness: 10 nm), a fifth interface layer 214 (thickness: 3 nm), and a fourth dielectric layer 213 (thickness: 65 nm).

ZnS—SiO₂ (SiO₂: 20 mol %) was used for the respective dielectric layers 204, 208, 212, 213, and 217; Ge—N was used for the respective interface layers 205, 207, 209, 211, 214, 216, and 218, and an Ag alloy was used for the respective reflective layers 210 and 219. A material represented by Ge_{2.7}Sn_{1.3}Sb₂Te₇ was used for the first recording layer 206. A material represented by Ge₄Sb₂Te₇ was used for the second recording layer 215.

The respective dielectric layers 204, 208, 212, 213, and 217 were formed by subjecting a target material of ZnS—SiO₂ to high-frequency sputtering in an Ar atmosphere. The respective interface layers 205, 207, 209, 211, 214, 216, and 218 were formed by subjecting a target material of Ge to high-frequency sputtering in a mixed gas atmosphere of Ar gas and nitrogen gas. The first recording layer 206 was formed by subjecting a target material of a Ge—Sn—Sb—Te alloy to DC sputtering in an Ar gas atmosphere. The second recording layer 215 was formed by subjecting a target material of a Ge—Sb—Te alloy to DC sputtering in an Ar gas atmosphere. The respective reflective layers 210 and 219 were formed by subjecting a target material of an AG alloy to DC sputtering.

Next, the first recording layer 206 and the second recording layer 215 were, respectively, initialized, i.e., crystallized. Thereafter, the first information layer a and the second information layer b were bonded with a UV-curable resin to produce a sample. At this time, the thickness of an adhesive layer 203 was set to 25 μm.

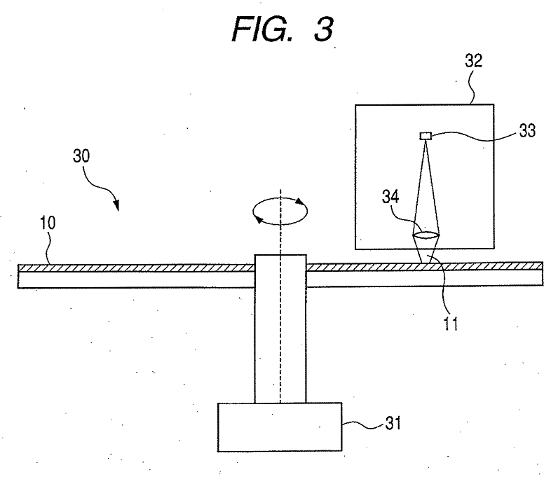

The phase-change type multi-layer optical recording medium thus produced was measured for recording/reproducing characteristics, using a recording/reproducing apparatus such as shown in FIG. 3. The recording/reproducing apparatus 30 includes a spindle motor 31 for rotating the multi-layer optical recording medium 10, and an optical head 32. The optical head 32 includes a semiconductor laser 33 for emitting a laser beam 11, an objective lens 34 for collecting the laser beam 11, and a photodiode (not shown) for detecting the laser beam 11 reflected by the multi-layer optical recording medium 10. The wavelength of the laser beam 11 was 405 nm, and the numerical aperture of the objective lens 34 was 0.85. The linear velocity during recording/reproduction was set to 2.5 m/s.

As described above, information was recorded by modulating the irradiating laser beam 11 to a high peak power Phigh (mW) and a low bias power Pb (mW). The temperature was raised to a crystallization temperature or more by the irradiation of the laser beam of the Phigh, followed by rapidly cooling, whereby an amorphous phase was formed to become a recording mark. At a region between the recording marks, the temperature was raised to a crystallization temperature or more by the irradiation with the laser beam of the Pb, followed by slow cooling, whereby a crystal phase was formed.

When information is recorded/reproduced to or from the first information layer a having the first recording layer 206, the laser beam 11 is irradiated with a focus being placed on the first recording layer 206. Information is reproduced by detecting a difference in reflected light amount between the amorphous phase forming a recording mark and the crystalline phase, from the laser beam 11 reflected by the first recording layer 206. When information is recorded/reproduced to or from the second information layer b having the second recording layer 215, the laser beam 11 is irradiated with a focus being placed on the second recording layer 215. Information is reproduced by detecting the laser beam 11 that has been reflected by the second recording layer 215 and has transmitted through an intermediate layer (i.e., adhesive layer) 203 and the first information layer a.

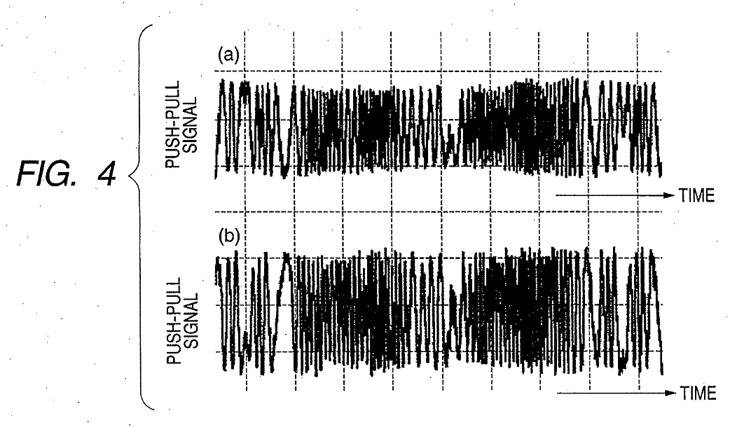

A push-pull signal was confirmed in each information layer, using the above-mentioned recording and reproducing apparatus, and signals such as shown in FIG. 4 were obtained. Part (a) of FIG. 4 shows a push-pull signal of the information layer a, and part (b) of FIG. 4 shows a push-pull signal of the information layer b. It can be seen from the result that the amplitude of the push-pull signal from the information layer b is larger than that from the information layer a. Furthermore, the tilt margin necessary for stabilizing the tracking servo was approximately the same between the two information layers, and the two information layers each had a sufficient margin. The reason for this is that on the information layer b which is more distant from the light incident surface and has a disadvantage with respect to the tilt, a groove is formed such that the push-pull signal amplitude increases, and consequently, the information layer b has approximately the same tilt margin as that of the information layer a.

The outputs of a photodiode in a reproducing/detecting system from the respective information layers in an initialized state were the same. This means that the amounts of reflected light from the respective information layers in the initialized state are the same. The output of the photodiode can be adjusted by changing the groove shape of each information layer and the film thickness of each thin film layer.

After recording was performed repeatedly 100,000 times, both the information layer a and the information layer b exhibited a jitter of 13% or less. Thus, it was seen that the optical recording medium can withstand repeated recording of at least 100,000 times.

Next, as a comparative example, an optical recording medium was produced by following the same procedure as in the above example with the exception that a groove recording substrate with a track pitch of 320 nm, a groove width of 150 nm, and a groove depth of 34 nm was used for the substrate 201 of the first information layer a. The optical recording medium thus produced was measured for repeated recording characteristics in the same manner as in the example, and consequently, rewriting could not be performed in the information layer a.

As is seen from the results of the comparison between the example and the comparative example described above, even in the optical recording medium using a recording layer having a small film thickness, recording sensitivity with respect to light can be enhanced by forming a groove shape in accordance with the present invention. As a result, a multi-layer optical recording medium composed of a recoding layer having a very small film thickness can be realized easily, in which satisfactory recording/reproduction can be performed.

To the above-mentioned, in the multi-layer optical recording medium of the present invention, in order to secure such transmitting property of a laser beam as to reach a recording layer which is more distant from the light incident surface, a recording layer which is closer to the light incident surface needs to be formed in a smaller film thickness.

Furthermore, in order to perform recording (or erasing) with respect to a recording layer, a crystalline phase needs to be formed in the recording layer, and in order to form a crystalline phase, the recording layer needs to be temperature-raised to a crystallization temperature or more and then slowly cooled.

In the multi-layer optical recording medium of the present invention, the recording layer which is closer to the light incident surface has a large heat capacity per bit, so that the recording layer which is closer to the light incident surface can easily store heat energy owing to a higher heat accumulating effect thereof. Therefore, the second recording layer is likely to be subjected to slow cooling, which is required for forming a crystalline phase, without being rapidly cooled. To be more specific, if the second recording layer is subjected to irradiation with a laser beam required for raising the temperature of the second recording layer to a crystallization temperature or more, a predetermined amount of heat is accumulated in the second recording layer owing to the heat capacity thereof, even if the laser irradiation is for a short period of time, whereby the second recording layer is slowly cooled and crystallized satisfactorily. Thus, even in the multi-layer optical recording medium having a very thin recording layer for further multilayering, satisfactory recording/reproducing characteristics can be realized.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-311377, filed Oct. 26, 2005 which is hereby incorporated by reference herein in its entirety.

What is claimed is:

1. A multi-layer optical recording medium, comprising:
a substrate; and
at least two recording layers each having a groove which are stacked on the substrate,
wherein the groove of a recording layer other than a recording layer which is most distant from a light incident surface of the at least two recording layers is deeper than the groove of the recording layer most distant from the light incident surface.

2. The multi-layer optical recording medium according to claim 1, wherein the depths of the grooves of the at least two recording layers are sequentially increased with decreasing distance from the light incident surface.

3. A multi-layer optical recording medium, comprising:
a substrate; and
at least two recording layers each having a groove which are stacked on the substrate,
wherein a recording layer other than a recording layer which is most distant from a light incident surface of the at least two recording layers is smaller in amplitude of push-pull signal based on a groove than the recording layer most distant from the light incident surface.

4. The multi-layer optical recording medium according to claim 3, wherein the amplitudes of push-pull signals based on the grooves of the at least two recording layers are sequentially decreased with decreasing distance from the light incident surface.
